(19) United States
(12) Patent Application Publication
(10) Pub. No.: US 2011/0271212 A1
(43) Pub. Date: Nov. 3, 2011

(54) MANAGING MULTIPLE CONFERENCES VIA A CONFERENCE USER INTERFACE

(76) Inventors: BOLAND T. JONES, Atlanta, GA (US); DAVID MICHAEL GUTHRIE, Norcross, GA (US); SCOTT LEONARD, Atlanta, GA (US); JOHN KEANE, Marietta, GA (US)

(21) Appl. No.: 13/078,277

(22) Filed: Apr. 1, 2011

Related U.S. Application Data
(63) Continuation-in-part of application No. 12/771,979, filed on Apr. 30, 2010.

(30) Foreign Application Priority Data
Apr. 30, 2010 (US) PCT/US2010/033084

(51) Int. Cl. G06F 3/048; G06F 15/16

(52) U.S. Cl. 715/753

(57) ABSTRACT

Various embodiments of systems, methods, and computer programs are disclosed for managing multiple conferences via a conference user interface. One such method comprises: a conferencing system establishing a current conference, via a communication network, between a host and a first set of participants, the current audio conference having a first scheduled timeslot; during the current conference, the conferencing system: receiving, via the communication network, a request from one or more of a second set of participants to join a next conference between the host and the second set of participants, the next audio conference having a second scheduled timeslot; establishing the next conference between the second set of participants; and notifying the host that the second set of participants have joined the next conference; the conferencing system terminating the current conference; and in response to terminating the current conference, the conferencing system automatically adding the host to the next conference.

### CROSS-REFERENCE TO RELATED APPLICATIONS

This application is a continuation-in-part patent application of the following copending pending applications, each of which are hereby incorporated by reference in their entirety: U.S. patent application Ser. No. 12/771,979 entitled “Conferencing Alerts” and filed on Apr. 30, 2010; International Patent Application Serial No. PCT/US2010/033084 entitled “Systems, Methods, and Computer Programs for Providing a Conference User Interface” and filed on Apr. 30, 2010; and U.S. patent application Ser. No. 12/772,069 entitled “Managing Conference Sessions via a Conference User Interface” and filed on Apr. 30, 2010.

### BACKGROUND

Currently, there are a number of conference solutions for enabling people to conduct live meetings, conferences, presentations, or other types of gatherings via the Internet, the public switched telephone network (PSTN), or other voice and/or data networks. Participants typically use a telephone, computer, or other communication device that connects to a conference system. The meetings include an audio component and a visual component, such as, a shared presentation, video, whiteboard, or other multimedia, text, graphics, etc. These types of convenient conference solutions have become an indispensable form of communication for many businesses and individuals.

Despite the many advantages and commercial success of existing conference, meeting, grouping or other types of gathering systems, there remains a need in the art for improved conference, meeting, grouping or other types of gathering systems, methods, and computer programs.

### SUMMARY

Various embodiments of systems, methods, and computer programs are disclosed for managing multiple conferences via a conference user interface. One such method comprises: a conferencing system establishing a current conference, via a communication network, between a host and a first set of participants, the current conference having a first scheduled timeslot; during the current conference, the conferencing system: receiving, via the communication network, a request from one or more of a second set of participants to join a next conference between the host and the second set of participants, the next conference having a second scheduled timeslot; establishing the next conference between the second set of participants; and notifying the host that the second set of participants have joined the next conference; the conferencing system terminating the current conference; and in response to terminating the current conference, the conferencing system automatically adding the host to the next conference.

Another such method comprises: a conferencing system establishing a first audio conference, via a communication network, between a first set of participants; a conferencing system establishing a second audio conference, via the communication network, between a second set of participants, the first and second sets of participants having at least one common participant and the first and second audio conferences having at least a portion of the respective audio conferences occurring simultaneously; the conferencing system presenting a conference user interface to a client device associated with the common participant, the conference user interface comprising a multi-conference presentation control component for selectively designating, during the simultaneous portion, one of the first and second audio conferences as a primary conference and the other as a secondary conference; and the conference user interface presenting the primary conference to the common participant with enabled audio and the secondary conference with disabled audio.

### BRIEF DESCRIPTION OF THE DRAWINGS

FIG. 1 is a block diagram illustrating an embodiment of a computer system for controlling simultaneous presentation of multiple conferences via a conference user interface.

FIG. 2 is a screen shot illustrating an embodiment of a conference user interface for enabling a participant to control simultaneous presentation of multiple conferences.

FIG. 3 is a flow chart illustrating the architecture, operation, and/or functionality of an embodiment of the multi-conference presentation control module(s) of FIG. 1.

FIG. 4 is a block diagram illustrating an embodiment of a data structure for controlling a common participant's audio stream between a primary conference and a secondary conference.

FIG. 5 is a block diagram illustrating an embodiment of a computer system for providing a conference waiting room functionality.

FIG. 6 is a flow chart illustrating the architecture, operation, and/or functionality of an embodiment of the conference waiting room module(s) of FIG. 5.

FIG. 7 is a screen shot illustrating an embodiment of a conference user interface for a conference that has been placed in a waiting room pending completion of a current conference.

FIG. 8 is a screen shot illustrating an embodiment of a conference user interface for a current conference displaying a waiting room notification.

FIG. 9a is a screen shot illustrating an embodiment of a conference user interface that simultaneously displays a current conference and a next conference waiting room.

FIG. 9b illustrates the screen shot of FIG. 9a in which a participant is moved from the current conference to the next conference.

### DETAILED DESCRIPTION

Various embodiments of systems, methods, and computer programs are disclosed for managing multiple conferences via a conference user interface. The term “multiple conferences” refers to two or more conferences associated with at least one common participant. Each conference may comprise an online conference, meeting, grouping, or other types of gatherings (collectively, a “conference”, with a system that provides the conference being referred to as a “conferencing system”) for any variety of purposes of one or more people, groups or organizations (including combinations thereof and collectively referred to as “participants”) with or without an audio component, including, without limitation, enabling simulcast audio with such conference for the participants. Exemplary embodiments of the conference, conferencing system, conference user interface, and related features may be implemented as described in the parent patent applications, U.S. patent application Ser. Nos. 12/771,979, 12/789,993, and 12/772,069, the entire contents of which are hereby incorporated by reference into this specification.

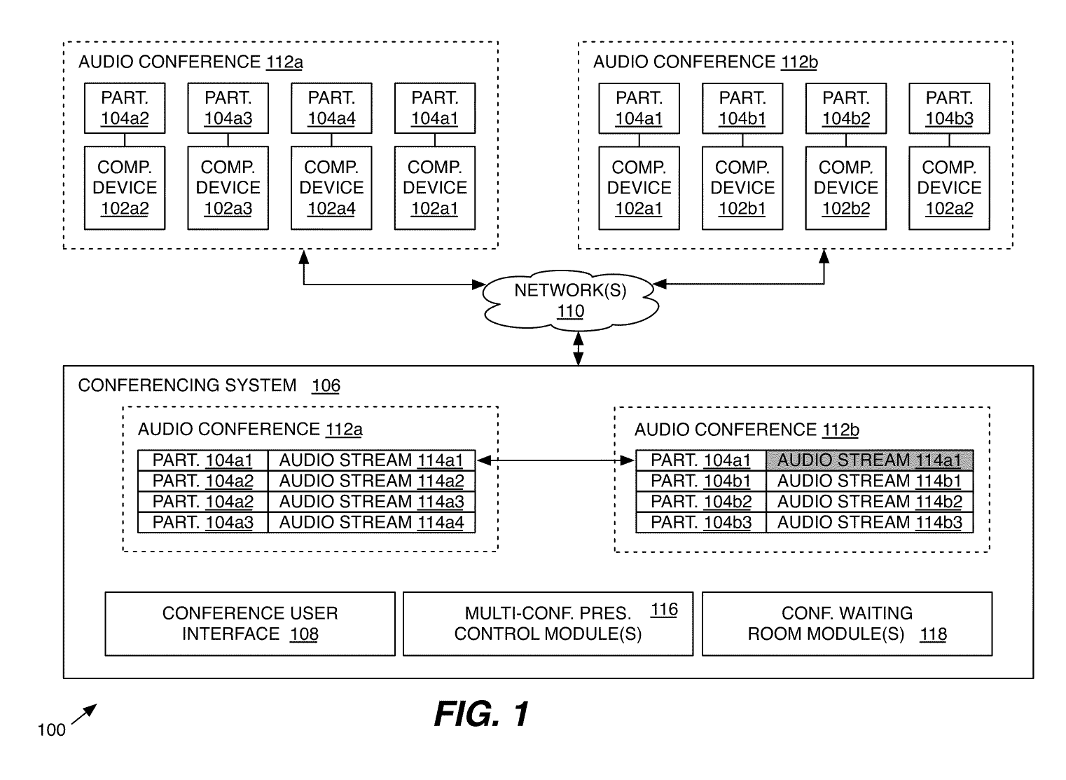

FIG. 1 illustrates a computer system 100 representing an exemplary working environment for managing multiple conferences. The computer system 100 comprises a plurality of computing devices 102 in communication with a conferencing system 106 via one or more communication networks 110. The network(s) 110 may support wired and/or wireless communication via any suitable protocols, including, for example, the Internet, the Public Switched Telephone Network (PSTN), cellular or mobile network(s), local area network(s), wide area network(s), or any other suitable communication infrastructure. The computing devices 102 may be associated with corresponding participants 104 of an audio conference 112.

The conferencing system 106 may establish two separate audio conferences 112 in which there is at least one common participant (i.e., participating in both audio conferences 112). As illustrated in the example of FIG. 1, audio conference 112a comprises four participants 104a1, 104a2, 104a3, and 104a4. Audio conference 112b comprises four participants 104a1, 104b1, 104b2, and 104b3. Participant 104a1 is a participant in both audio conferences 112a and 112b.

The computing devices 102 may comprise any desirable computing device, which is configured to communicate with the conferencing system 106 via the networks 110. The computing device 102 may comprise, for example, a personal computer, a desktop computer, a laptop computer, a mobile computing device, a portable computing device, a smart phone, a cellular telephone, a landline telephone, a soft phone, a web-enabled electronic book reader, a tablet computer, or any other computing device capable of communicating with the conferencing system 106 via one or more networks 110. The computing device 102 may include a display device, a processor, memory, and software, including an operating system, a graphical user interface, a browser, or other functionality configured to facilitate communication with the conferencing system 106. It should be appreciated that the hardware, software, and any other performance specifications of the computing device 102 are not critical and may be configured according to the particular context in which the computing device 102 is to be used.

The conferencing system 106 generally comprises a communication system for establishing an audio conference 112 between the computing devices 102. The conferencing system 106 may support audio via a voice network and/or a data network. In one of a number of possible embodiments, the conferencing system 106 may be configured to support, among other platforms, a Voice Over Internet Protocol (VoIP) conferencing platform such as described in U.S. patent application Ser. No. 11/637,291 entitled “VoIP Conferencing,” filed on Dec. 12, 2006, which is hereby incorporated by reference in its entirety. It should be appreciated that the conferencing system 106 may support various alternative platforms, technologies, protocols, standards, features, etc. Regardless of the communication infrastructure, the conferencing system 106 may be configured to establish an audio connection with the computing devices 102, although in some embodiments the audio portion may be removed. As illustrated in FIG. 1, the conferencing system 106 may establish the audio conferences 112a and 112b by combining audio streams 114 associated with the computing devices 102. The common participant 104a1 has an audio stream 114a1 shared between the audio conferences 112a and 112b.

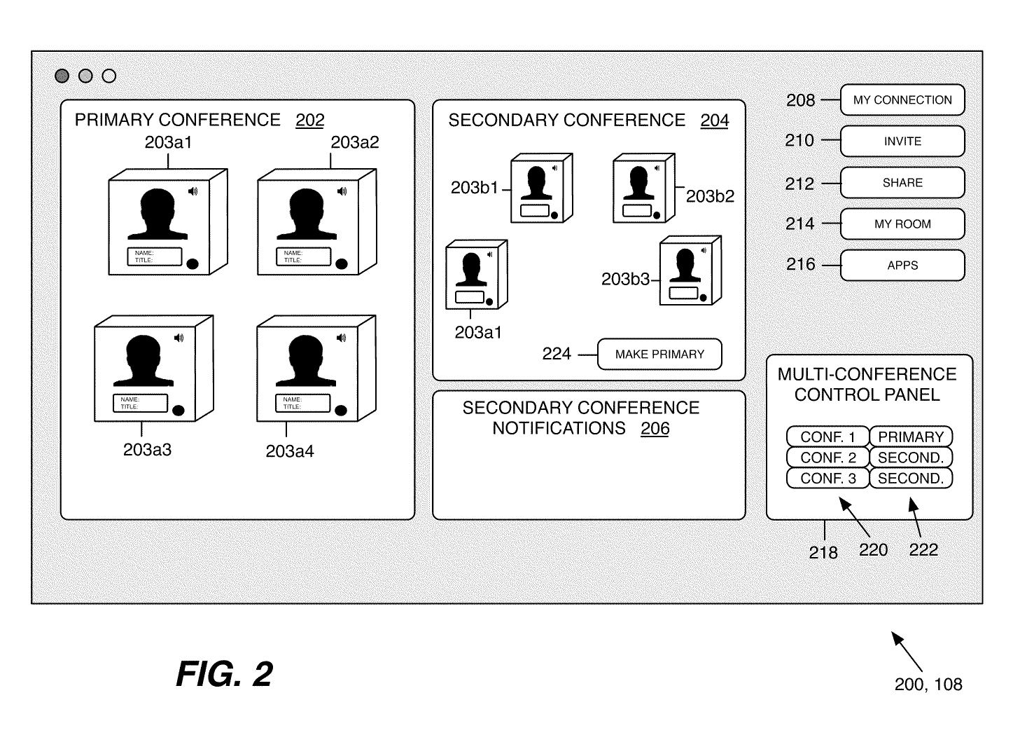

The conferencing system 106 presents a conference user interface 108 to participants 104 in association with the corresponding audio conference 112. The conferencing system 106 further includes multi-conference presentation control module(s) 116 and conference waiting room module(s) 118 that comprise the logic or functionality for providing various features related to managing the multiple conferences (e.g., audio conferences 112a and 112b). The multi-conference presentation control module(s) 116 and conference waiting room module(s) 118 are described below in more detail with reference to FIGS. 2-9. However, in general, the multi-conference presentation control module(s) 116 enable the common participant 104a1 to simultaneously view (in the conference user interface 108) both conferences, and selectively designate one conference as a primary conference and the other as a secondary conference. The conference waiting room module(s) 118 provide a sub-conference (referred to as “a conference waiting room”) in the event there is a timing conflict between two scheduled conferences associated with a user account. For example, a current scheduled conference may run over the planned timeslot creating a time conflict with a next scheduled conference, or participants 104 for the next scheduled conference may prematurely join the conference while the current conference is still active. While the common participant 104a1 is engaged in the current scheduled conference, the participants 104 for the subsequent scheduled conference may be placed in the conference waiting room pending completion of the current conference.

One of ordinary skill in the art will appreciate that the multi-conference presentation control module(s) 116 and the conference waiting room module(s) 118 (and any associated or other modules described herein) may be implemented in software, hardware, firmware, or a combination thereof. In one embodiment, the systems are implemented in software or firmware that is stored in a memory and that is executed by a suitable instruction execution system. In software or firmware embodiments, the logic may be written in any suitable computer language. In hardware embodiments, the systems may be implemented with any or a combination of the following, or other, technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

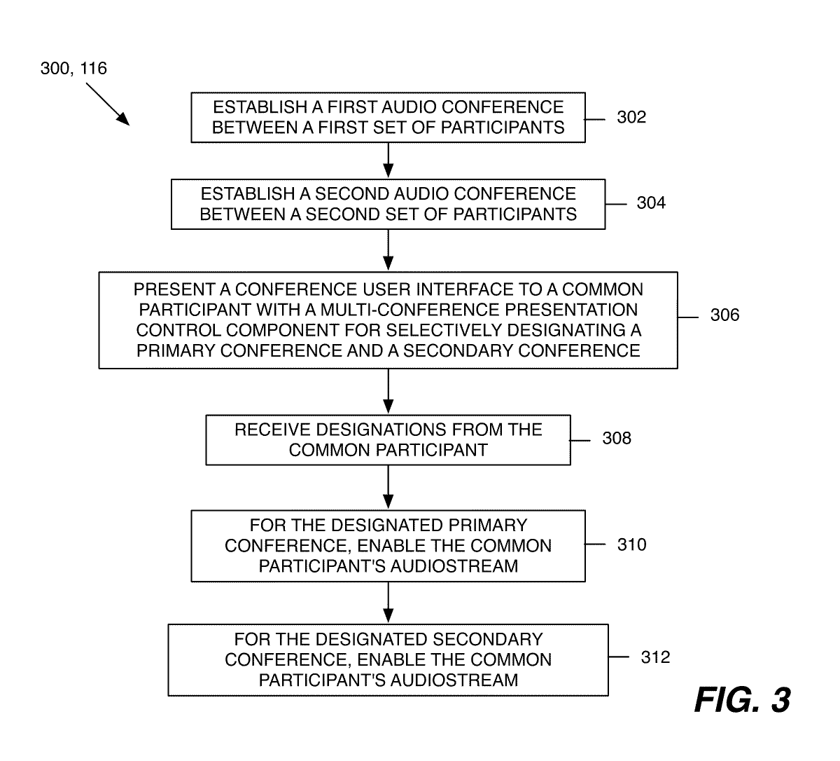

FIG. 3 illustrates a method 300 implemented by an embodiment of the multi-conference presentation control module(s) 116. At block 302, the conferencing system 106 establishes a first audio conference (e.g., audio conference 112a) between a first set of participants 104a1, 104a2, 104a3, and 104a4. At block 304, the conferencing system 106 establishes a second audio conference (e.g., audio conference 112b) between a second set of participants 104a1, 104b1, 104b2, and 104b3. The participant 104a1 is a participant of both audio conferences 112a and 112b, and at least a portion of the respective audio conferences 112a and 112b occur simultaneously. At block 306, the conferencing system 106 presents a conference user interface 108 to the common participant 104a1. FIG. 2 illustrates an exemplary embodiment of the conference user interface 108. During the simultaneous portion of the audio conferences 112a and 112b, the conference user interface 108 displays a first display region 202 associated with one of the audio conferences and a second display region 204 associated with the other audio conference. It should be appreciated that two or more conferences may be simultaneously displayed depending on the number of active conferences. Display region 202 corresponds to a primary conference, and the display region 204 corresponds to a secondary conference.

In the example of FIG. 2, the primary conference corresponds to audio conference 112a and the secondary conference corresponds to audio conference 112b. Display regions 202 and 204 display unique participant objects 203 for each of the participants in the audio conference. Display region 202 displays unique participant objects 203a1, 203a2, 203a3, and 203a4 that correspond to the participants 104a1, 104a2, 104a3, and 104a4, respectively. Display region 203 displays unique participant objects 203a1, 203b1, 203b2, and 203b3 that correspond to the participants 104a1, 104b1, 104b2, and 104b3, respectively. As described in the above-referenced parent patent applications, the unique participant objects 203 may comprise a graphical representation identifying the participant, profile or contact information, an audio indicator, and other information about the participant. The graphical representation may comprise a picture, photograph, icon, avatar, etc. for identifying the corresponding participant 104.

In the embodiment of FIG. 2, the participant objects 203 comprise a cube having multiple display faces. When a participant 104 selects a user interface component, the cube may be expanded to display one or more faces of the object. The user selection may trigger the display of cube faces. Each face may display additional information about the participant. In an embodiment, the cube faces may be configurable by the participant and may display, for example, a social networking profile, updates to a social networking communication channel, video, graphics, images, or any other content. The cube faces may be further selected to return to the original collapsed cube. The participant objects 203 may be rotated (either automatically or via user selection) to display the respective cube faces. It should be appreciated that the participant objects 203 may be configured with additional or alternative visual effects and/or interactive functionality.

As further illustrated in FIG. 2, the conference user interface 108 may comprise one or more selectable components for accessing various features of the conferencing system 106. A my connection component 208 may launch a display for enabling a participant 104 to configure the existing connection between the computing device 102 and the conferencing system 106. The participant 104 may disconnect a connection to the audio conference 112, establish a new connection to the audio conference 112 (e.g., by dial-out), or reconfigure the existing connection to the audio conference 112. In addition to configuring the audio connection, the participant 104 may also configure the connection to the online conference via the conference user interface 108. In an embodiment, the connection to the online conference may be transferred to another computing device 102 or another client on an existing computing device 102. This may enable the participant 104 to seamlessly maintain a presence in the online conference during the transfer.

An invite component 210 may launch a menu for enabling a participant 104 to invite additional participants 104 to the online conference. Additional participants may be invited by, for example, dialing out to a telephone number, sending an email including information for accessing the conferencing system 106 (including a presently active conference), or sending a message to a web service, such as, for example, a social networking system.

A share component 212 may launch a menu for enabling a participant 104 to insert and share media with other participants in the online conference. A my room component 214 may launch a display for enabling a participant 104 to configure the appearance of the conference user interface 108. The participant 104 may configure the arrangement of the participant objects 203 or configure any other presentation parameter.

An apps component 216 may launch another menu for enabling a participant 104 to launch conference applications. As described in the above-referenced parent patent applications, the conferencing system 106 may host a conference apps store for purchasing various conference applications. An app store component may launch the app store where the participant 104 may purchase conference applications. The my apps component may launch a display for enabling the participant 104 to select from applications that have already been purchased or are otherwise available to the participant 104. A host apps component may display conferencing applications that have been made available by the host of the online conference.

The conference user interface 106 may further display, present, or otherwise expose a multi-conference presentation control component for enabling the common participant 104a1 to selectively designate the primary conference and the secondary conference. For example, a Make Primary button 224 may be displayed in the display region 204 associated with the secondary conference. When the Make Primary button 224 is selected the status of the conferences may be toggled. It should be appreciated that the toggle operation may be controlled via any suitable input command, such as, for example voice commands or a hotkey (e.g., a predetermined keystroke). In alternative embodiments, the control mechanism may be implemented via a multi-conference control panel 218, which lists all current conferences in which the participant 104a1 is participating. The control panel 218 may display a conference identifier 220 and a corresponding selection button 222 for designating the status of the conference.

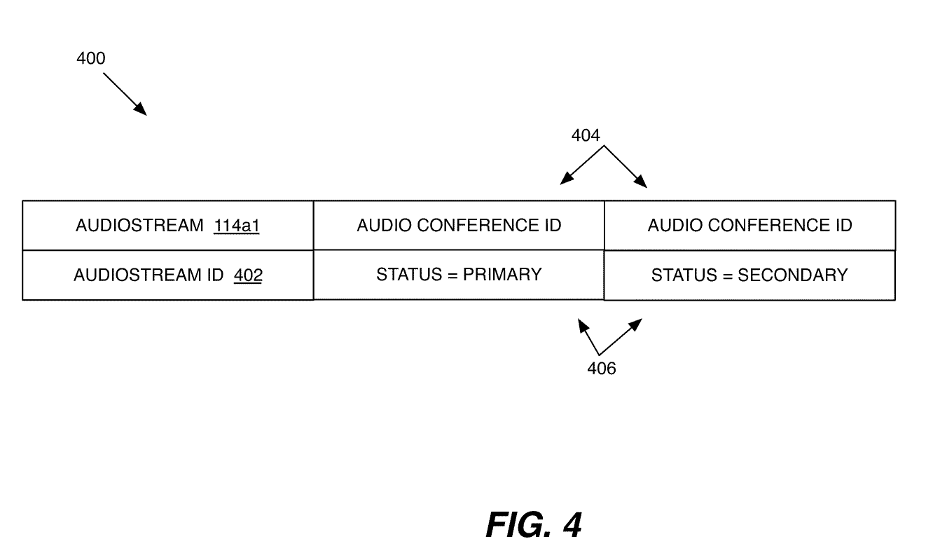

Referring again to the flowchart of FIG. 3, at block 308, the conferencing system receives the status designations selected by the common participant 104a1. As illustrated at blocks 310 and 312, the conferencing system 106 may enable audio for the primary conference and disable audio for the secondary conference. In this manner, the common participant 104a1 may orally participate in the primary conference, while the audio is disabled in the secondary conference. The conferencing system 106 may control the common participant's audio stream 114a1 via, for example, the exemplary data structure in FIG. 4. Audio conference 112a may be identified with an audio conference identifier 404a, and the audio conference 112b may be identified with an audio conference identifier 404b. The status of the audio conferences, as either primary or secondary, may be maintained in a corresponding status identifier 406. The common participant's audio stream 114a1 may be added to the current audio conference 112 designated as primary.

While the audio is disabled for the secondary conference, the conferencing system 106 may monitor and provide various notifications to the common participant 104a1 in a secondary conference notifications display 206. For example, the conferencing system 106 may notify the common participant 104a1 of various conference events and/or enable the common participant 104a1 to interact with the secondary conference in any desirable way other than via the disabled audio connection.

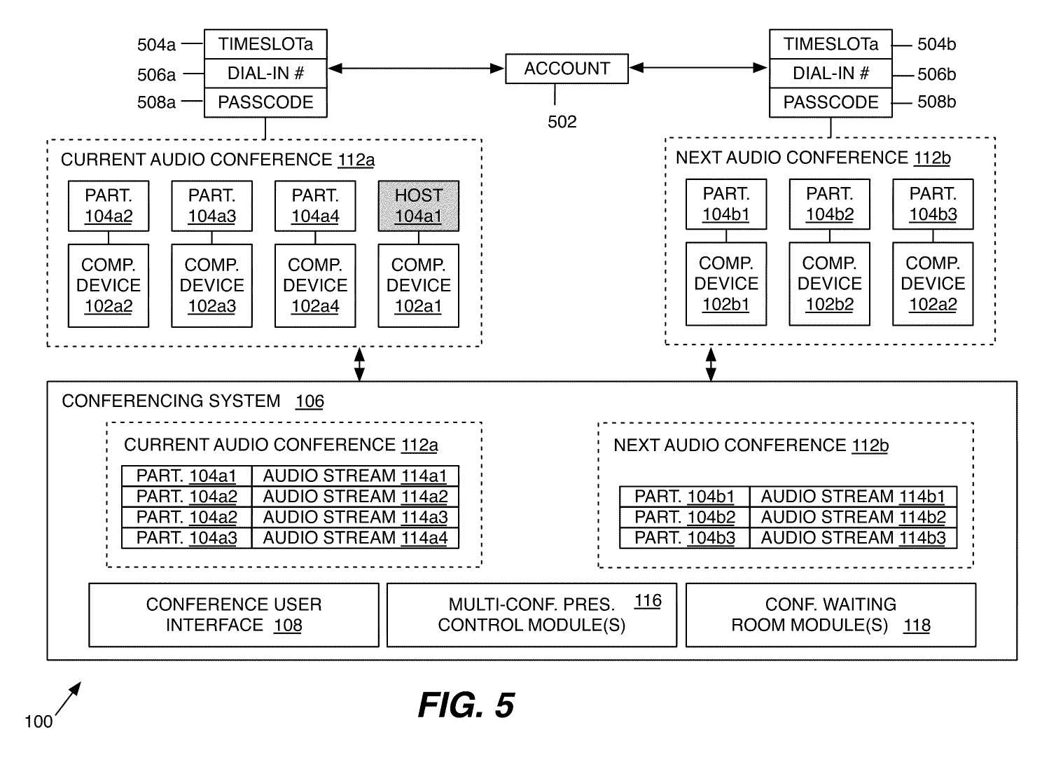

FIG. 5 illustrates the computing system 100 of FIG. 1 in connection with operation of the conference waiting room module(s) 118. As mentioned above, the conference waiting room module(s) 118 provide a conference waiting room in the event that a user account 502 has a timing conflict between two scheduled conferences. Audio conference 112a (i.e., a first or current conference) may have a first timeslot 504a, and audio conference 112b (i.e., a second, next, subsequent, or partially concurrent conference) may have a second timeslot 504b. Audio conference 112a is the same as described above in connection with FIG. 1 with the exception that the participant 104a1 may comprise a host having the account 502. The terms “host” and “participant” merely refer to different user roles or permissions associated with the conference. For example, the “host” may be the originator of the conference and, consequently, may have user privileges that are not offered to the participants. Nonetheless, it should be appreciated that the terms “host,” “participant,” and “user” may be used interchangeably depending on the context in which it is being used. Audio conference 112b is similar to the multi-conference presentation control embodiment with the exception that, in the conference waiting room embodiment, the common participant 104a1 does not simultaneously participate in the audio conferences 112a and 112b. Rather, the common participant 104a1 may configure the account 502 with the conference waiting room feature, which places participants for the second audio conference 112b in a sub-conference or a conference waiting room, while the common participant 104a1 is still active in the current audio conference 112a.

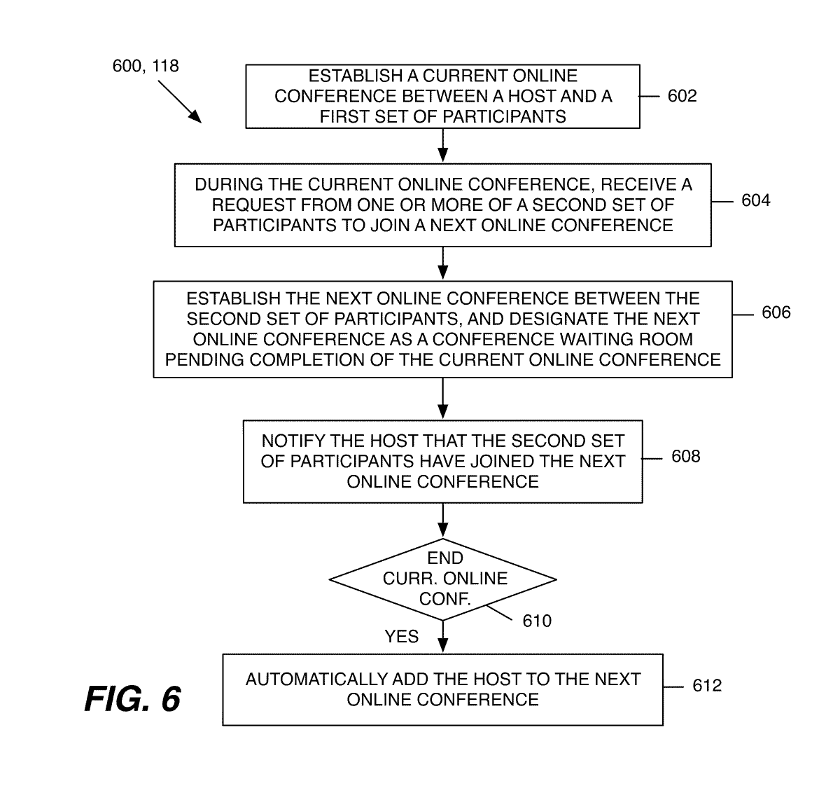

FIG. 6 illustrates an embodiment of a method 600 performed by the conferencing system 106 for implementing the conference waiting room module(s) 118. At block 602, the conferencing system 106 establishes a current conference (e.g., audio conference 112a) between a first set of participants. The current conference may be associated with the user account 502 for the common participant 104a1 and have a scheduled timeslot 504a, as well as a dial-in number 506a and a passcode 508a for enabling the participants 104a1, 104a2, 104a3, and 104a3 to access the audio conference 112a. During the current conference, at block 604, the conferencing system 106 may receive a request from one or more of a second set of participants 104b1, 104b2, and 104b3 to join the next conference (e.g., audio conference 112b) associated with the account 502. The next conference may have a scheduled timeslot 504b (which may or may not coincide partially with the scheduled timeslot 504b). The next conference has a dial-in number 506b and a passcode 508b. Dial-in number 506b and passcode 508b may be the same or different than dial-in number 506a and passcode 508b. In an embodiment, the conferencing system 106 may use different dial-in numbers and/or passcodes as a mechanism to differentiate and manage the simultaneous conferences. However, it should be appreciated, that the conferencing system 106 may alternatively use the identities of one or more participants to differentiate between the simultaneous conferences.

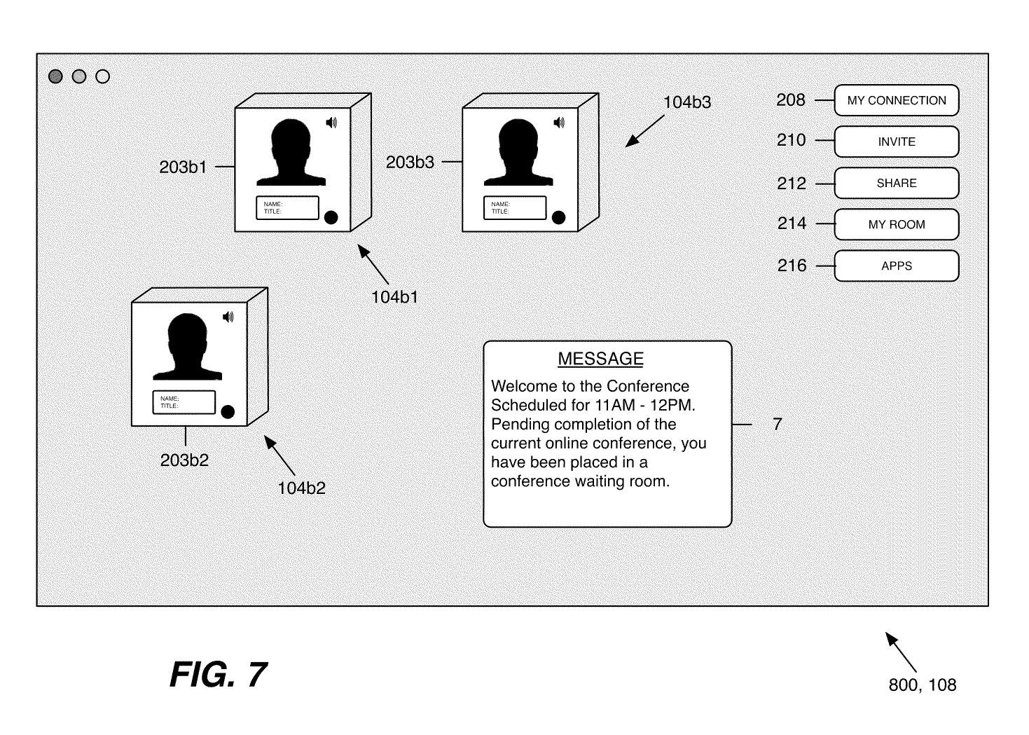

At block 606, if the request to join the next conference is received while the current conference is active, the conferencing system 106 may establish the audio conference 112b as a sub-conference or conference waiting room pending completion of the current conference. For example, in the exemplary screen shot 700 of FIG. 7, the conferencing system 106 may present the conference user interface 108 for the next conference with a message 702 notifying the participants 104b that the scheduled conference has been placed in a waiting room status pending completion of the current conference. While in the waiting room status, the participants 104b may interact with each other via the audio conference 112b or the conference user interface 108 pending the common participant joining the next conference. In this manner, the common participant 104a1 (who may be a host or merely a required participant for the next conference) may simultaneously finish the current conference while enabling the participants 104b in the next conference to get acquainted.

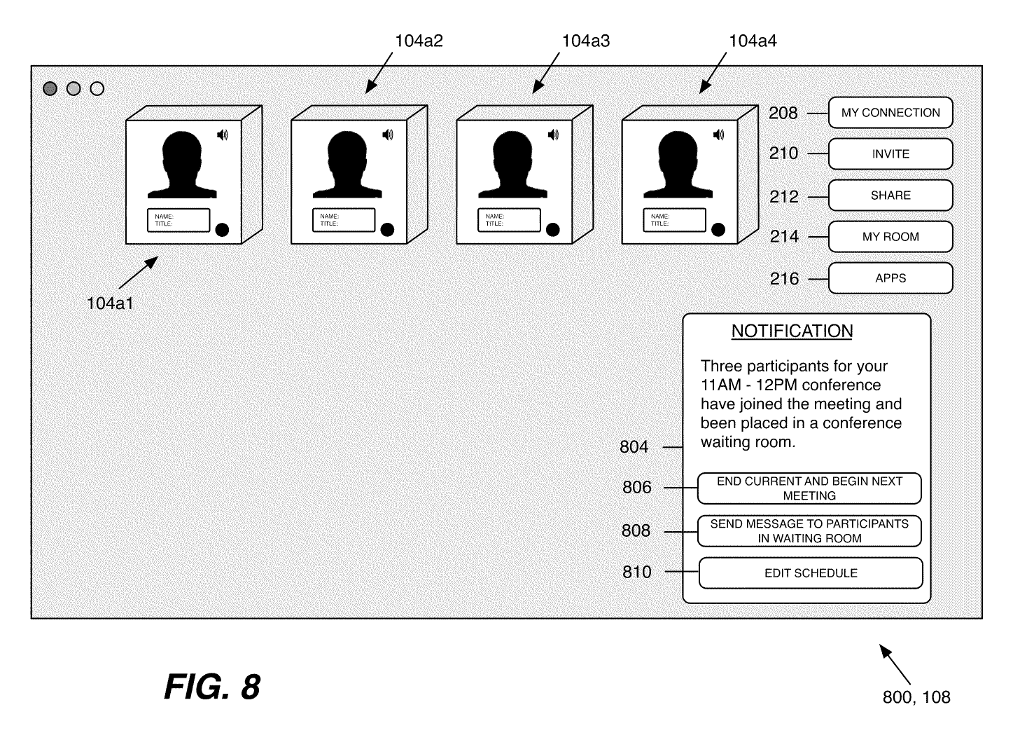

At block 608, the conferencing system 106 may notify the common participant 104a1 that one or more participants 104b have joined the next conference. As illustrated in FIG. 8, the conference user interface 108 presented to the common participant 104a1 may include a message 804 indicating that one or more participants 104b have joined the next conference. The message 804 may include a button 806 for enabling the common participant 104a1 to end the current conference and automatically begin the next meeting by adding the common participant to audio conference 112b. A button 808 may enable the common participant 104a1 to send a message to the participants 104b in the conference waiting room (e.g., “Will Be 5 Minutes Late”). The message may be manually composed or selected from a default list. The common participant 104a1 may also edit the conference schedule by selecting a button 810, which exposes a menu for changing the timeslot 504b and notifying the participants 104b, via the conference user interface 108, of the revised meeting time.

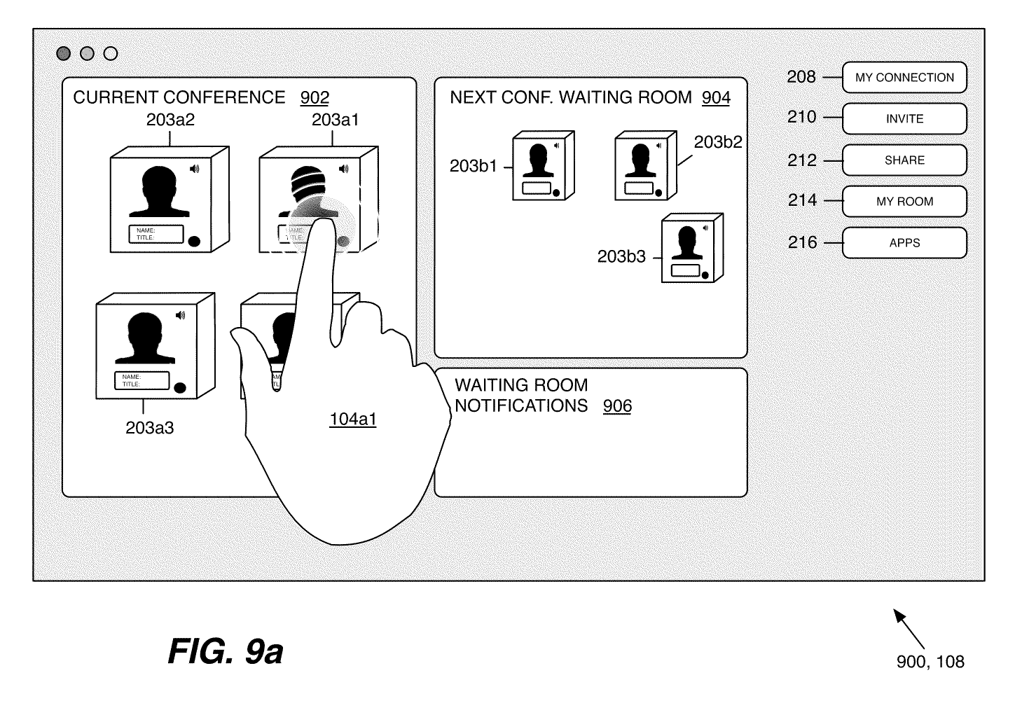

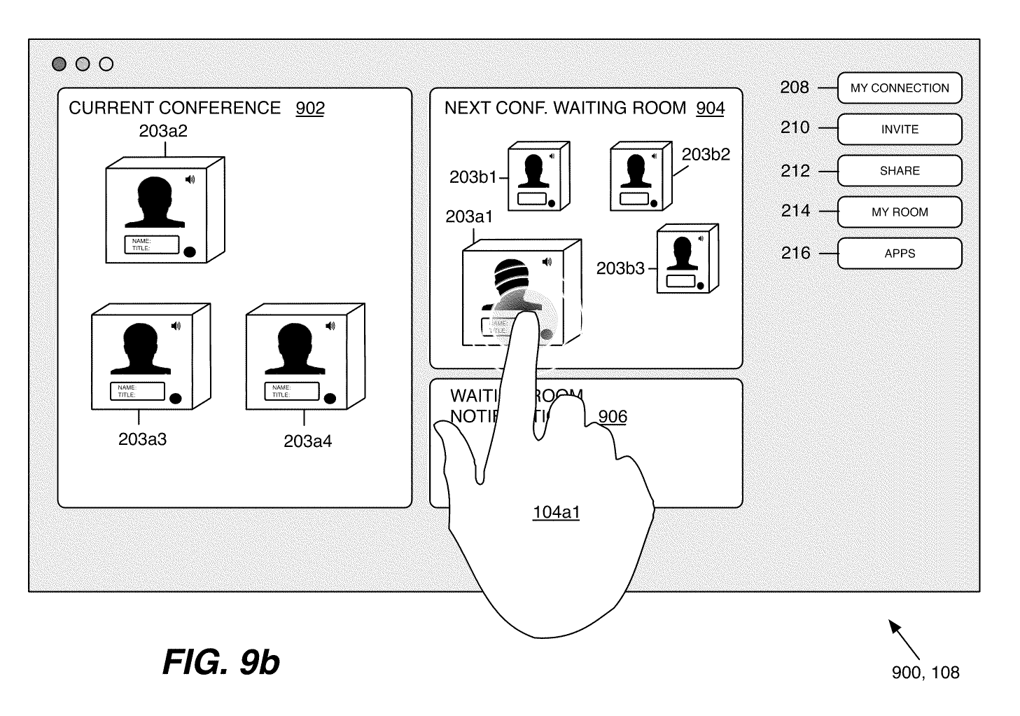

FIGS. 9a & 9b illustrate another embodiment of a conference user interface 108 for presentation to the common participant 104a1 while the current and next conferences are simultaneously active. A current conference display 902 may display unique participant objects 203 associated with the corresponding participants in the current conference. A next conference waiting room display 904 may display unique participant objects 203 associated with the participants in the conference waiting room. Similar to the secondary conference notifications display 206 (FIG. 2), the conferencing system 106 may monitor events occurring in the conference waiting room and provide event notifications to the common participant 104a1 via a waiting room notifications display 906.

The common participant 104a1 may terminate the current conference in any manner while the participants 104b are placed in the conference waiting room (decision block 610). In response to terminating the current conference, at block 612 (FIG. 6), the conferencing system 106 may automatically add the common participant 104a1 to the next conference, notify the participants 104b, and commence the next conference. As illustrated in FIGS. 9a & 9b, the common participant 104a1 may join the next conference by performing a drag-and-drop operation on his/her unique participant object 203a1, in the manner described in the above-referenced parent patent applications.

It should be appreciated that one or more of the process or method descriptions associated with the flow charts or block diagrams above may represent modules, segments, logic or portions of code that include one or more executable instructions for implementing logical functions or steps in the process. It should be further appreciated that the logical functions may be implemented in software, hardware, firmware, or any combination thereof In certain embodiments, the logical functions may be implemented in software or firmware that is stored in memory or non-volatile memory and that is executed by hardware (e.g., microcontroller) or any other processor(s) or suitable instruction execution system associated with the multi-platform virtual conference location system. Furthermore, the logical functions may be embodied in any computer readable medium for use by or in connection with an instruction execution system, apparatus, or device, such as a computer-based system, processor-containing system, or other system associated with the multi-platform virtual conference location system that can fetch the instructions from the instruction execution system, apparatus, or device and execute the instructions.

It should be noted that this disclosure has been presented with reference to one or more exemplary or described embodiments for the purpose of demonstrating the principles and concepts of the invention. The invention is not limited to these embodiments. As will be understood by persons skilled in the art, in view of the description provided herein, many variations may be made to the embodiments described herein and all such variations are within the scope of the invention.

What is claimed is:

1. A method for managing multiple conferences via a conference user interface, the method comprising:
a conferencing system establishing a current audio conference, via a communication network, between a host and a first set of participants, the current audio conference corresponding to a host account with the conferencing system and having a first scheduled timeslot;
during the current audio conference, the conferencing system:
receiving, via the communication network, a request from one or more of a second set of participants to join a next audio conference between the host and the second set of participants, the next audio conference corresponding to the host account and having a second scheduled timeslot;
establishing the next audio conference between the second set of participants; and
notifying the host that the second set of participants have joined the next audio conference;
the conferencing system terminating the current audio conference; and
in response to terminating the current audio conference, the conferencing system automatically adding the host to the next audio conference.

2. The method of claim 1, wherein the conferencing system automatically adding the host to the next audio conference comprises:
identifying a host audio stream; and
combining the host audio stream with the next audio conference.

3. The method of claim 1, wherein the conferencing system automatically adding the host to the next audio conference comprises combining an audio stream associated with the next audio conference with a host audio stream associated with the current audio conference.

4. The method of claim 1, wherein the first and second scheduled timeslots do not overlap, and the current audio conference is still active after the first scheduled timeslot.

5. The method of claim 1, wherein the conferencing system notifying the host, during the current audio conference, that the second set of participants have joined the next audio conference comprises: the conferencing system presenting a notification in a conference user interface to a client device associated with the host.

6. The method of claim 5, wherein the notification comprises a selectable user interface object.

7. The method of claim 6, further comprising:
the host selecting the user interface object;
in response to the host selecting the user interface object, the conferencing system terminating the current audio conference and automatically adding the host to the next audio conference.

8. The method of claim 1, wherein the establishing the next audio conference between the second set of participants comprises notifying the second set of participants via a conference user interface that the next audio conference is delayed pending completion of the current audio conference.

9. The method of claim 1, further comprising:
the conferencing system presenting a notification in a conference user interface to a client device associated with the host;
the host submitting to the conferencing system via the conference user interface a response indicating a revised starting time for the second scheduled timeslot; and
the conferencing system communicating the revised starting time to the second set of participants.

10. The method of claim 1, wherein the establishing the next audio conference between the second set of participants further comprises:
presenting a conference user interface to the second set of participants, via corresponding client devices in communication with the conferencing system;
the conference user interface displaying a participant object associated with each of the second set of participants; and
the conference user interface displaying a message that the next audio conference has been delayed pending completion of the current audio conference.

11. The method of claim 1, further comprising during the current audio conference:
the conferencing system presenting a conference user interface to a computing device associated with the host, the conference user interface graphically displaying each of the set of first participants in the current audio conference with a first set of unique participant objects.

12. The method of claim 11, further comprising the conference user interface graphically displaying each of the set of second participants in the next audio conference with a second set of unique participant objects.

13. The method of claim 12, further comprising the conferencing system presenting to the conference user interface event notifications associated with the next audio conference.

14. A method for managing multiple conferences via a conference user interface, the method comprising:
a conferencing system establishing a first audio conference, via a communication network, between a first set of participants;
a conferencing system establishing a second audio conference, via the communication network, between a second set of participants, the first and second sets of participants having at least one common participant and the first and second audio conferences having at least a portion of the respective audio conferences occurring simultaneously;
the conferencing system presenting a conference user interface to a client device associated with the common participant, the conference user interface comprising a multi-conference presentation control component for selectively designating, during the simultaneous portion, one of the first and second audio conferences as a primary conference and the other as a secondary conference; and
the conference user interface presenting the primary conference to the common participant with enabled audio and the secondary conference with disabled audio.

15. The method of claim 14, wherein the multi-conference presentation control component comprises a user interface toggle.

16. The method of claim 14, wherein the multi-conference presentation control component comprises an assigned hotkey.

17. The method of claim 14, further comprising:
the common participant toggling the primary conference and the secondary conference via the multi-presentation control component.

18. The method of claim 14, further comprising:
the conference user interface presenting event notifications associated with the secondary conference.

19. A method for managing multiple conferences via a conference user interface, the method comprising:
a conferencing system establishing a current conference, via a communication network, between a host and a first set of participants, the current conference having a first scheduled timeslot;
during the current conference, the conferencing system:
receiving, via the communication network, a request from one or more of a second set of participants to join a next conference between the host and the second set of participants, the next conference having a second scheduled timeslot;
establishing the next conference between the second set of participants; and
notifying the host that the second set of participants have joined the next conference;
the conferencing system terminating the current conference; and
in response to terminating the current conference, the conferencing system automatically adding the host to the next conference.

20. The method of claim 19, wherein one or more of the current conference and the next conference comprises one or more of an audio conference, a video conference, and a web conference.
